(19) United States
(12) Patent Application Publication
(10) Pub. No.: US 2009/0125948 A1
(43) Pub. Date: May 14, 2009

(54) Communication Processing Based on Television Use

(75) Inventors: Matthew R. Kuhlke, San Francisco, CA (US); Gebran G. Chahrouri, Menlo Park, CA (US); Labhesh Patel, San Francisco, CA (US); Sanjeev Kumar, Sunnyvale, CA (US); Mukul Jain, San Jose, CA (US); Shmuel Shaffer, Palo Alto, CA (US)

Correspondence Address: BAKER BOTTS L.L.P., 2001 ROSS AVENUE, SUITE 600, DALLAS, TX, 75201-2980, US

(73) Assignee: Cisco Technology, Inc., San Jose, CA (US)

(21) Appl. No.: 11/938,459

(22) Filed: Nov. 12, 2007

(51) Int. Cl. G06F 3/00

(52) U.S. Cl. 725/58

(57) ABSTRACT

In one embodiment, a method includes receiving a first user profile comprising at least one rule associated with at least one show. The at least one rule is activated upon the occurrence of a first event. The method also includes detecting the occurrence of the first event. Upon detecting the occurrence of the first event, the method further includes activating the at least one rule and processing a first communication based on the at least one rule.

### TECHNICAL FIELD OF THE INVENTION

This invention relates in general to communication processing based on television use.

### BACKGROUND

As various different types of service providers merge with one another a trend has emerged for them to provide customers with unified service packages. This typically results in companies bundling different services together and/or providing a single bill. The bundled services typically still rely on their previous technology or network, that is to say the phone service still uses a public switched telephone network (PSTN), the television uses a separate cable or satellite signal, and the internet is usually by modem (dial-up), cable or digital subscriber line (DSL). Because these services are still separate there is not much integration or interaction between them.

One exception has been the growth of various network technologies. For example, the Internet Protocol not only allows users to surf the internet, but it also allows users to make phone communications using Voice over IP (VOIP), and to watch television using IPTV. While VOIP has been around longer and has begun to gain mainstream acceptance, IPTV is still relatively young. Furthermore, there is not yet much interaction between these services.

Communication processing based on personal preferences is a commonly known tool for handling incoming communications. Devices that handle the scheduling of communication processing may sometimes be referred to as personal assistants (PA). However, these products currently rely on static information that has to be programmed in beforehand. For example, a user may program his PA to forward all communications that come in on Monday between 7:00 and 10:00 p.m. to his voice mail because that is when he likes to watch football. Thus the user is required to manually enter where and when to route communications. Some upcoming products even allow a user to route communications based on their meeting schedule from their calendaring software. For example, if a user has a meeting from 1:00 to 2:30 p.m., he may have his communications routed to voicemail during this time.

### BRIEF DESCRIPTION OF THE DRAWINGS

For a more complete understanding of particular embodiments and their advantages, reference is now made to the following description, taken in conjunction with the accompanying drawings, in which:

FIG. 1 illustrates several components of a sample home media network, in accordance with particular embodiments;

FIG. 2 illustrates a more detailed block diagram, including components of a personal assistant, in accordance with particular embodiments; and

FIG. 3 illustrates a method for routing communications based on television use, in accordance with particular embodiments.

### DESCRIPTION OF EXAMPLE EMBODIMENTS

Overview

In accordance with particular embodiments, a method includes receiving a first user profile comprising at least one rule associated with at least one show. The at least one rule is activated upon the occurrence of a first event. The method also includes detecting the occurrence of the first event. Upon detecting the occurrence of the first event, the method further includes activating the at least one rule and processing a first communication based on the at least one rule.

Description

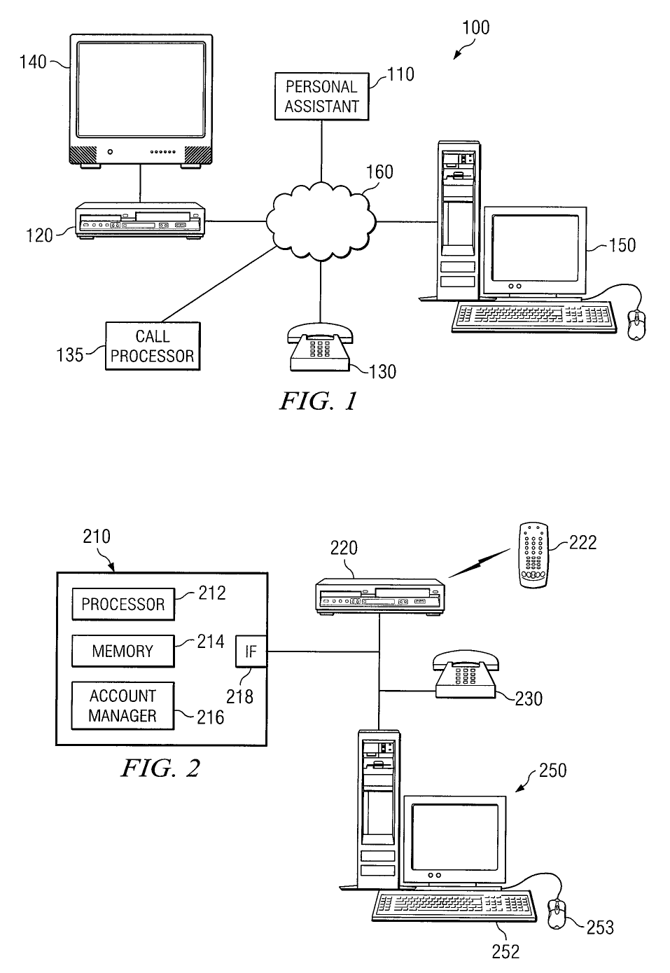

FIG. 1 illustrates several components of a sample home media network, in accordance with particular embodiments. Home media network 100 includes network 160 which couples personal assistant 110, set-top box 120, IP phone 130, call processor 135, TV 140 and computer 150 with one another. Each of these components may be able to send and receive data using packet based protocols such as the Internet Protocol (IP). By sharing an ability to communicate with one another using a common protocol the components of home network 100 may be able to provide communication processing based on television use. While these components have been depicted as coupled to one another via network 160, depending on the scenario and configuration, one or more of the components may be coupled directly to one another. For example, personal assistant 110 may be directly coupled to set-top box 120 and IP phone 130 (in addition to the direct connection, one or more of these components may also have a connection with network 160). Though not depicted, two or more of these components may also be connected via secondary connections, such as Bluetooth connections.

For purposes of simplicity, the term show may be used to generally refer to any television program, movie, home video, video clip, media file (e.g., a .wmv file), previously recorded show, live show, or any source or type of audio/visual presentation. Similarly, for simplicity, the term communication may be used to generally refer to a phone call, text message, instant message, email, video conference or any other type of electronic communication containing any type of media content.

A user may use any of the components of home media network 100 (e.g., personal assistant 110, set-top box 120 or computer 150) to enter information about the shows she likes to watch and what she would like to happen should a communication be received while she is watching the show. Set-top box 120 may be able to determine what show the user is watching and report this to personal assistant 110. If the user has indicated that she does not want to be disturbed during the show, then personal assistant 110 may notify, for example, IP phone 130 and/or call processor 135 that any incoming communications should be re-routed until further notice. If a communication is received while the user is watching the show, it may be routed according to any rules stored by personal assistant 110.

Personal assistant 110 (or its functionality), while depicted as a single separate component, may be a part of set-top box 120, IP phone 130, call processor 135, TV 140 or computer 150 or its components may be distributed throughout home media network 100. Personal assistant 110 may be responsible for storing a user's profile including any rules concerning the who, what, where, and when of communication processing. Personal assistant 110 may be able to save multiple different profiles for several different users, or several different profiles for a single user. Some of the information that may be stored by personal assistant 110 may include information about the type of shows that the user likes to watch. This information may be as specific as the name of a show to as general as a broad genre of shows. The following illustrates some of the variety of ways in which the user can identify shows: the user may enter the name of a show; the user may enter a type of sport or a name of a team involved in a show; the user may enter a type of show (e.g., movie, sitcom, reality show, news); the user may enter the timing of a show to distinguish between shows that are live, new, or re-run; the user may enter the source of the show (e.g., the specific channel, whether the show is coming off an antennae, a digital video recorder or from a cable/satellite company, or if it is in standard definition or high definition); the user may enter the name of an actor, director or producer involved in a show; the user may enter any other information that may be used to distinguish or sort between shows; or the user may enter a combination of two or more of these categories or other categories. Some examples of combinations may be that the user specifies he does not want to be interrupted during any live Lakers games or during any comedies starring Jim Carrey on channel 4. Personal assistant 110 may also receive and store information about how communications are to be routed. For example, the user may specify that incoming communications should be routed to voice mail or an alternate number, such as a cell phone. Besides the destination for a routed communication, personal assistant 110 may also receive and store information related to which types of communications should be routed. For example, the user may specify that all communications should be routed to his voicemail except a communication from his girlfriend. As another example, the user may specify that all communications from telemarketers, 1-800 numbers, unknown or no caller-ID numbers should be routed to a special “junk-mail” voicemail box. In some embodiments, personal assistant 110 may monitor more than just phone communications, in which case the user may specify what items are to be routed. For example, the user may specify that IM messages should be saved in a separate window and an automatic reply sent specifying how long the user would be unavailable.

Personal assistant 110 may not only receive data from a user but may also receive data from set-top box 120. Personal assistant 110 may also send information to set-top box 120. For example, personal assistant 110 may transmit information, such as the user's personal preferences, to set-top box 120 regarding which shows the user likes and request that set-top box 120 alert personal assistant 110 when the user is watching one of those shows. As alluded to above, this exchange may occur through network 160, directly between personal assistant 110 and set-top box 120, or otherwise.

Similarly, personal assistant 110 may communicate with IP phone 130. In some embodiments or configurations, personal assistant 110 may be functionally located between IP phone 130 and network 160. Thus, whenever an incoming communication is received, it first passes through personal assistant 110. This may allow personal assistant 110 to redirect or intercept any communication that needs to be rerouted before it reaches IP phone 130. In particular embodiments, personal assistant 110 may not function as an intermediary but may simply transmit messages to IP phone 130 and/or call processor 135 informing it/them when it/they can accept communications and when it/they need(s) to reroute communications (and where the communications should be rerouted). In return, IP phone 130/call processor 135 may send information to personal assistant 110 informing it, for example, that a communication has been received or rerouted and the ID of the initiator.

Set-top box 120 may be any type of decoder or other component used to receive packet based, off-air, satellite or cable transmission of television programs. Set-top box 120 may also be able to record shows for later viewing. In some embodiments, a digital video recorder (DVR) that records shows for later viewing may be coupled to set-top box 120. This may be an additional source of shows. Set-top box 120 may also receive additional information such as a schedule of upcoming shows (e.g., a program guide). Besides receiving the shows and information concerning their scheduling, set-top box 120 may also send and receive data with personal assistant 110. For example, set-top box 120 may be able to generate and present presence information. The presence information may alert personal assistant 110 as to whether TV 140 is on, what channel is being watched, what show is being watched, who is watching the show, how long the show lasts, or any other information related to the viewing of a show that personal assistant 110 may want or could use. Set-top box 120 may be able to collect some of this information internally. For example, set-top box 120 may know what channel has been selected, and the current time. This internal information may, for example, be used to determine the name of the show being watched. Some of the information may come from external sources. For example, set-top box 120 may use an external source to determine whether TV 140 is on or off. As another example, a user may use a remote control to enter a login ID and/or password. This may allow set-top box 120 to determine who is viewing a particular show. In some embodiments, a digital camera may be coupled to set-top box 120 to allow a digital image of the user to be taken. This image may then be compared to a database stored within set-top box 120, or within personal assistant 110, to determine the ID of the user watching a particular show. In particular embodiments, set-top box 120 may be coupled to a fingerprint scanner which may be able to determine the ID of the user from his fingerprint.

IP phone 130 may be any phone operable to send and/or receive voice or video telecommunications using any combination of components that may be able to share and exchange information. For example, IP phone 130 may be able to exchange and share information over an IP network or use any other communication modality. In some embodiments, IP phone 130 may be able to communicate with personal assistant 110. For example, personal assistant 110 may send instructions to IP phone 130 specifying when and where to route incoming communications. Upon receiving/routing a communication, IP phone 130 may send a message to personal assistant 110 alerting personal assistant 110 of the incoming/re-routed communication. Personal assistant 110 may store this information so that it may be presented to the user at a later time, or it may send a message (e.g., a caller ID message) to set-top box 120 to be displayed on TV 140.

Call processor 135 may be any combination of hardware, software, and/or encoded logic operable to provide call routing, handling, and/or processing. In particular embodiments, call processor 135 may be able to communicate with personal assistant 110. For example, personal assistant 110 may send instructions to call processor 135 specifying when and where to route incoming communications. Upon receiving/routing a communication, call processor 135 may send a message to personal assistant 110 alerting personal assistant 110 of the incoming/re-routed communication. Personal assistant 110 may store this information so that it may be presented to the user at a later time, or it may send a message (e.g., a caller ID message) to set-top box 120 to be displayed on TV 140. In particular embodiments, call processor 135 may be coupled to several IP phones. Accordingly, call processor 135 may be able to selectively route an incoming communication to all, some or none of the coupled IP phones. For example, if the user is watching a show downstairs, call processor 135 may route an incoming communication to IP phones upstairs nut not downstairs.

TV 140 may be a television, projector, monitor, screen, or any other type of display device. For example, TV 140 may be a plasma display, a cathode ray tube (CRT) display, or an LCD display. In some embodiments, TV 140 may be able to explicitly send a message to set-top box 120 or personal assistant 110 alerting them when it has been turned on or turned off. TV 140 may also be able to communicate information regarding the show that is being watched or the channel that is currently selected. In some embodiments, TV 140 and set-top box 120 may be a single integrated device.

Computer 150 may be any type of computer, including a desktop computer, notebook, PDA, smartphone, or any other computing device. Computer 150 may be able to communicate with personal assistant 110. For example, a user may be able to use computer 150 to enter their show and/or communication processing preferences. A user may also be able to view information from personal assistant 110 using computer 150. For example, after a user has finished watching a show, he may use computer 150 to view a log of the communications that were received and re-routed during the show. In some embodiments, personal assistant 110 may also maintain a log of who watched what shows when; this information may also be accessed by a user via computer 150. Computer 150 may be local (e.g., within the same building) with respect to the other components of home media network 100 or it may be remote (e.g., at a hotel or office). Thus, a user may be able to access and view the data stored by personal assistant 110 even when they are away from home. For example, the user may use computer 150 to enter and update information about the shows he likes or check up on his kids to see what they have been watching while he is away from home.

Although network 160 is depicted as a single network, in practice network 160 may comprise any number of IP or non-IP communication networks of any wireless or wireline form capable of communicating audio and/or video telecommunication signals, data, and/or messages, including signals, data or messages. For example, network 160 may comprise a local area network (LAN), wide area network (WAN), cellular network, global distributed network such as the Internet, Intranet, Extranet, PSTN, LMR network, CDMA network, GSM network, TDMA network, satellite network or any other form of wireless or wireline communication network. Network 160 may include any number and combination of segments, nodes and endpoints to enable communication among network devices and components. Network 160 may be distributed locally or across multiple cities and geographic regions. Network 160 may include any combination of network components, gatekeepers, communication managers, conference bridges, routers, hubs, switches, gateways, base stations, endpoints or other hardware, software or embedded logic implementing any number of communication protocols that allow for the exchange of data in network 160. The segments of network 160 may comprise any suitable wireless or wireline communication links, including one or more additional networks. The segments may couple various networks with each other and with other endpoints or components.

Communications or transmissions within network 160 may use any suitable communication protocol. In particular embodiments, voice communication protocols that allow for the addressing or identification of endpoints, nodes, and/or other components coupled to the communication network may be used. For example, each of the components coupled together by an IP network may be identified in information directed using IP addresses. In this manner, the IP network may support any form and/or combination of point-to-point, multicast, unicast, or other techniques for exchanging media packets among components coupled thereto. Any network components capable of exchanging audio, video, or other data are included within the scope of particular embodiments. IP networks transmit data (including voice and video data) by placing the data in packets and sending each packet individually to the selected destination along one or more communication paths. Unlike a circuit-switched network (like a PSTN), a dedicated circuit is not required for the duration of a communication or fax transmission over IP networks.

Since IP networks share a common method of transmitting data, telecommunication signals may be transmitted between telephony devices located on different, but interconnected, IP networks. These IP networks may also be coupled to non-IP telecommunication networks, for example through the use of interfaces or components, such as gateways. This may allow a device coupled to an IP network to communicate with a device coupled to a non-IP network. For example, if a PSTN phone was to send a communication to IP phone 130, one or more gateways may be used. A PSTN may include switching stations, central offices, mobile telephone switching offices, pager switching offices, remote terminals, and other related telecommunications equipment located throughout the world.

Technology that allows telecommunications to be transmitted over an IP network may comprise Voice over IP (VoIP), or simply Voice over Packet (VoP). IP phone 130 may be an IP telephony device capable of participating in IM, video, and other multimedia communication sessions. Additionally, call processor 135 may be capable of receiving, processing, and routing phone, IM, video, or other incoming multimedia telecommunications. IP telephony devices have the ability of encapsulating a user's voice (or other input) into IP packets so that the voice can be transmitted over a communication network. IP telephony devices may include telephones, call processors, fax machines, computers running telephony software, nodes, gateways, wired or wireless devices, hand held PDAs, or any other devices capable of performing telephony functions over an IP network.

Although FIG. 1 illustrates a particular number and configuration of components, home media network 100 contemplates any number or arrangement of such components for communicating media. For example, set-top box 120 may be able to supply media to multiple TV's; similarly personal assistant 110 may interact with several set-top boxes. Additional information on time-adaptive control of television viewing functionality is included in U.S. Pat. No. 7,120,922 which is incorporated by reference herein.

FIG. 2 illustrates a more detailed block diagram including components of a personal assistant, in accordance with particular embodiments. Personal assistant 210 may include any combination of hardware, software, and/or encoded logic that provides personal assistant services, such as facilitating communication processing based on TV usage, to a user. In the illustrated embodiment, personal assistant 210 includes processor 212, memory 214, account manager 216, and interface 218. In other embodiments, personal assistant 210 may include more, fewer or different components than those depicted in FIG. 2. Furthermore, these components may be within a single device or distributed among several devices. Additionally, these components may be coupled together through one or more communication networks, such as network 160 of FIG. 1. Personal assistant 210 may be coupled to set-top box 220, IP phone 230, and computer 250. These components may be similar to the corresponding components depicted in FIG. 1. For simplicity, neither a television nor a call processor have been depicted. Accordingly, any reference to set-top box 220 may include a reference to a set-top box (e.g., set-top box 120) or a television (e.g., television 140) and any reference to IP phone 230 may include a reference to an IP phone (e.g., IP phone 130) or a call processor (e.g., call processor 135).

Processor 212 may be a microprocessor, controller, or any other suitable computing device, resource, or combination of hardware, software and/or encoded logic operable to provide, either alone or in conjunction with other personal assistant 210 components (e.g., memory 214 and account manager 216) personal assistant functionality. Such functionality may include providing various features discussed herein to a user. One feature that certain embodiments may provide may include rerouting communications without disturbing a user while he watches his favorite show(s). A user may use any appropriate input device (e.g., remote 222, computer 250, or IP phone 230) to enter information such as where the communication is to be routed, a list of TV shows or types of TV shows during which the user does not want to be disturbed and any other features or benefits the user wants to employ. This information may be saved as a user profile or user account. Based on the rules within the user profile, as well as input from other devices, processor 212 may determine when and where to route incoming communications. Other features of particular embodiments may include contacting one user (e.g., a parent) whenever another user (e.g. a child) is watching TV.

Memory 214 may be any form of volatile or non-volatile memory including, without limitation, magnetic media, optical media, random access memory (RAM), read-only memory (ROM), removable media, or any other suitable local or remote memory component. Memory 214 may store any suitable data or information, including software and encoded logic, utilized by personal assistant 210. For example, memory 214 may maintain a listing, table, or other organization of information about users, including user profiles. This information may then be used by processor 212 and/or account manager 216 to determine when and where incoming communications should be routed. For example, account manger 216 may use memory 214 to store a user's profile. Then, when processor 212 determines that the user is watching TV, it may query memory 214 to determine if the show being watched by the user is one of his favorite shows. If it is, processor 212 may consult the user's profile to determine how any incoming communications should be processed.

Account manager 216 may include policies for undertaking various operations and functionality upon the occurrence of various events to provide dynamic communication processing based on a particular user's television use. These policies may include automatically generated rules, user defined rules as well as rules that are a combination of both. In some embodiments, the policies may include rules/guidelines for combining policies (e.g., where two users are watching a show at the same time). These rules/guidelines may be referred to as meta rules. Each user profile maintained by account manager 216 may include its own set of rules unique to that user. For example, one user may want all incoming communications to be automatically routed to voicemail while another user may want to see who the initiator is before the communication is routed to voicemail. More specifically, assume that a first user is willing to accept a call while he is watching a golf tournament and a second user prefers to have incoming calls forwarded to voicemail while he is watching a golf tournament. The conflicting preferences may be resolved by the meta rules to provide guidance regarding call handling during a golf tournament being watched by the first and second user. One possible resolution may be that if the first user began watching the golf tournament before the second user then the first user's preferences (call may be accepted) may have priority over the second user's preferences. In some instances, upon routing an incoming communication a pager or e-mail notification may be transmitted.

Interface 218 may comprise any hardware, software, or encoded logic needed to be able to send and receive information with other media components, such as set-top box 220, IP phone 230, or computer 250. Interface 218 may be used in the communication of audio, video, signaling and other data between personal assistant 210 and other media components. For example, personal assistant 210 may receive a message from IP phone 230 alerting personal assistant 210 that an incoming communication has been detected. The message may take place over wire or wireless IP networks thereby negating the need for dedicated wiring between the components.

For simplicity, some of the features and functionality of particular embodiments will be explained within the context of the following examples. These examples are merely to help illustrate some of the features and functionality of particular embodiments and are not intended to be exhaustive or limiting of other embodiments.

A user may be at work when he hears about a show that he wants to watch. He then goes to computer 250, which is located at his office, and logs into a webpage that allows him to set the show as one he wants to watch and to indicate that he does not want to be disturbed during the show. The information regarding the show may be a request or other type of message that is sent to personal assistant 210 (or directly entered into personal assistant 210). It should be noted that the user may simply select the show without having to enter any other information (e.g., times or dates). Assume that prior to this the user had configured personal assistant 210 such that when the user indicates that he is not to be disturbed all incoming communications are to be routed to a messaging service which generates email records of any received communications.

Upon the request being received by interface 218, processor 212 may determine what actions are required to comply with the request and then may store the request and/or the determination in memory 214. In some instances this may involve updating account manager 216. Once processor 212 determines that the user has requested to not be disturbed during the show, interface 218 may send a request to set-top box 220 requesting that set-top box 220 alert personal assistant 210 when the show begins. Because personal assistant 210 may be waiting to hear from set-top box 220 before initiating any steps to have incoming communications rerouted, the user does not have to worry about making any changes if the show starts late, is cancelled, is re-scheduled or is otherwise not available at its originally scheduled time and location (e.g., channel). This may provide a way to dynamically adjust communication routing without relying on user input.

Depending on what the user is watching, as the time approaches for the start of the show personal assistant 210 or set-top box 220 may remind the user that the show is about to start, change the channel to the show's channel, configure set-top box 220 to record the show, or perform any other action the user may have configured personal assistant 210 to perform at the start of the show. If the user is watching the show, set-top box 220 may send the requested alert to personal assistant 210 informing it that the user is watching the show. If the user is not watching the show, for example he is watching a different show or he is not watching anything, then set-top box 220 may not send an alert to personal assistant 210. In some embodiments, whether a user is considered watching a show or not may depend on their physical presence. For example, set-top box 220 may include a camera or radio frequency identification (RFID) reader to determine the ID of a user. More specifically, in some embodiments, set-top box 220 may use a camera to take a picture of a particular area. Any faces within the area may be compared with a database of known users to determine who, if anyone, is watching TV. In particular embodiments, set-top box 220 may include an RFID reader which may be able to read any RFID tags within range to determine who, if anyone, is watching TV. In particular embodiments, the user may establish his presence via a fingerprint sensor on remote control 222.

Once interface 218 receives the alert from set-top box 220, processor 212 may consult account manager 216 to determine how the alert is to be handled. In this case, the user is not to be disturbed, so any incoming communications are to be routed to the messaging service. Interface 218 may then send IP phone 230 an appropriate command to inform it about how incoming communications should be routed. In some embodiments, personal assistant 210 (or any other component, such as IP phone 230) may answer the call and, based on the remainder of the show, inform the initiator of the call when the user may become available.

Once the show is over or the user stops watching it (e.g., changes channels, logs-off, or leaves the room), set-top box 220 may send personal assistant 210 a message indicating that the user is no longer watching the show. Personal assistant 210 may then inform IP phone 230 that it no longer needs to route communications to the messaging service.

In a similar scenario, the user may be browsing through a program guide through set-top box 220 looking for a show to watch. Upon seeing a show that looks good, the user may use remote 222 to select the show for later viewing. This may involve set-top box 220 setting up a timer to record the show or sending the user a reminder before the show begins (e.g., displaying a pop-up window on the TV reminding the user that the show is about to start). Set-top box 220 may also send a message to personal assistant 210 informing it that the user has selected to watch a particular show. In some embodiments, personal assistant 210 may proceed as it had when the request was made from computer 250: personal assistant 210 may set up a trigger with set-top box 220 to alert personal assistant 210 when the shows starts. Once the user starts watching the show IP phone 230 may be told to reroute communications according to the rules within the user's profile. In particular embodiments, because the user selected the show from set-top box 220, set-top box 220 may already be prepared to send an alert message to personal assistant 210 when the user watches the show. As before, this alert message may be sent whether the user watches the show during its normally scheduled time or whether he watches it at a later time (e.g., he records it or it is rescheduled). As may be apparent, any rerouting or changes in how incoming communications are processed is triggered by the show. Thus, personal assistant 210 may be able to automatically adapt to changes in scheduling or the users viewing habits without requiring any additional information or input from the user. Furthermore, any other airings of the show (e.g., other episodes, re-runs, video on demand requests, playback from a recording) may also be included without the user having to individually select each show.

Depending on the embodiment and configuration of personal assistant 210, the user may be provided with flexibility in shaping his rules. For example, the user may customize the features a show must meet (e.g., only new shows or only shows that he is watching for the first time) in order for his rule to be activated. Thus, even though set-top box 220 may alert personal assistant 210 that the user is watching one of his favorite shows, personal assistant 210 may still have to check the rule to determine if, where and how communications should be routed. For example, if the user is re-watching one of his favorite shows, then personal assistant may not re-route incoming communications.

Assume that before the user had selected the show, he had configured personal assistant 210 so that he would not be disturbed during certain shows. Further assume that he had configured personal assistant 210 so that if he is watching a recorded episode of one of those shows then he still wants communications re-routed to a messaging service, but he also wants a caller ID window to be displayed on his TV. Once the user begins to watch the recorded show, set-top box 220 may send the appropriate alert to personal assistant 210. Personal assistant 210 may activate the appropriate rule and inform IP phone 230. Accordingly, when a communication comes in while the user is watching the recorded show IP phone 230 re-routes the communication to the messaging service and sends a message containing information about the incoming communication to either personal assistant 210 or set-top box 220. This information may then be conveyed, either visually (e.g., a pop-up window) or audibly (e.g., a voice alert), to the user. In some embodiments, the user may elect to answer the communication by picking up the handset of IP phone 230. In particular embodiments the user may be able to answer the communication by pressing an appropriate button on remote 222.

In some embodiments, if the user pauses the show, set-top box 220 may send an alert to personal assistant 210 which may then alert IP phone 230 that the user has paused the show and that communications should, until further notice, no longer be routed to the messaging service. Similarly, if the camera or RFID of set-top box 220 determines that the user has left the room, or if the user logged off the system indicating that he is no longer watching the show, then IP phone 230 may no longer route incoming communications to the messaging service. This may be done even if the TV is still displaying the show (e.g., the user had to leave to take care of something but did not turn off the TV).

In some embodiments, the user may be able to identify a show as one which he does not want to be disturbed by simply pressing an appropriate button on remote 222 or set-top box 220. This may be desirable, for example, during a sporting event in which the user's favorite team is making a late-game come back and he does not want to miss any of the action.

Besides identifying shows during which the user does not want to be disturbed, personal assistant 210 or IP phone 230 may also be configured with exceptions. More specifically, the user's rule may contain information identifying certain callers whose call should not be re-routed to a messaging service even if the user is watching one of his favorite shows. The callers identified may be selected from the user's list of contacts and may be identified based on, for example, a caller ID when their calls are received.

In some embodiments where multiple users are watching TV at the same time, personal assistant 210 may use meta-rules to determine how different rules for different users should be combined and/or prioritized. These meta-rules may also be used when a single user has multiple rules that need to be resolved. For example, assume that a user has specified that incoming communications received while he is watching a baseball game are to be sent to voicemail and that calls received while he is watching a live show are to be forwarded to his cell phone. If the user is watching a live baseball game, personal assistant 210 may apply meta rules to determine whether an incoming communication should be sent to voice mail or to the user's cell phone.

It will be recognized that personal assistant 210 and the media components disclosed herein are merely example configurations in accordance with particular embodiments. These components may include any number of interfaces, processors, memory modules, and other components to accomplish the functionality and features described herein. In addition, these media components and other desired media components for performing the above described functionality may be centrally located (local) with respect to one another, or distributed throughout communication systems and networks. In addition, one or more media components may work together in performing any of the functionality described herein.

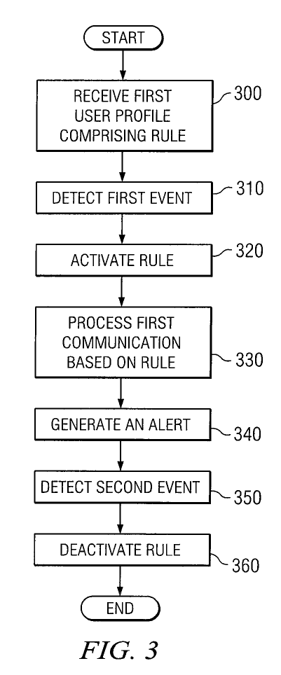

FIG. 3 illustrates a method for routing communications based on television use, in accordance with particular embodiments. The method begins at step 300 with the receipt of a first user profile comprising a rule. The first user profile may comprise any information, messages, or other data that may be used to determine when, how, and where incoming communications are to be processed and/or routed. The data that makes up the first user profile may be received all at once or it may be received in multiple different messages/communications. For example, the user may first send a request configuring his personal assistant to reroute any incoming calls that are received while he is watching a preferred show to voicemail. Then, in a subsequent message, the user may provide the personal assistant with a name of a preferred show. As another example, the user may, in a single message, provide the personal assistant with sufficient information to identify not only the preferred show but how incoming communications are to be handled.

The first user profile may be received from any of a variety of sources including any of the examples listed above with respect to FIGS. 1 and 2. For example, in particular embodiments the user may use a personal computer to select a preferred show. The user may also use his personal computer to set up a user profile that includes how incoming communications are to be handled. The user may use a set-top box to indicate preferred shows and/or how incoming communications are to be handled. For example, the user may use the set-top box to select a show from a program guide displayed on his TV.

The first user profile may comprise multiple rules. For example, the first user profile may have one rule for live shows and a different rule for pre-recorded shows. Additionally, the personal assistant may be able to store and manage several different user profiles. For example, each member of a family may have their own separate user profile or a single user may have different profiles for different scenarios. Each of these profiles may contain one or more rules. In order to resolve any conflicts that may arise between two or more profiles or rules, the personal assistant may include a set of meta rules. The meta rules may include instructions or guidance for determining priority between two or more conflicting rules. For example, a meta rule may specify that the least disruptive rule is applied, or that a more recent rule should have priority over an older rule.

In some embodiments, upon receiving the rule, the personal assistant may need to send a message to, for example, a set-top box alerting it of the rule or requesting it to perform some act or function based on the rule. For example, the message may request the set-top box send a message to the personal assistant when the user begins watching a particular show (e.g., a preferred show during which he does not want to be disturbed). In particular embodiments, upon receiving the rule, the personal assistant may begin to monitor presence information being sent by, for example, a set-top box. The presence information may be used by the set-top box to determine who is watching what, and thus when the rule should be activated.

Regardless of how the rule of the first user profile is received, at step 310 the first event is detected. In general, the first event is an event indicating that the user is watching one of his preferred shows. This may be determined in any of a variety of ways using a variety of equipment. Just some of the examples may include determining if the user is physically present in front of the TV, what devices are on, what channel is currently being viewed, what is the current time, and/or at what time/channel particular shows are scheduled.

Depending on the configuration of the components, the first user profile and/or the rule, detecting the first event may involve receiving a message from one of the components (e.g., any of the components depicted in FIG. 1). For example, detecting the first event may comprise receiving a message from a set-top box indicating that the user is watching a preferred show. As another example, detecting the first event may comprise receiving a request from the user (e.g., from the user's remote control) to watch a preferred show. In some embodiments, the set-top box may be configured to provide the personal assistant with presence information. In such an embodiment the personal assistant may detect the first event if the presence information indicates that the first user is watching a preferred show.

A variety of techniques and technology may be used by the set-top box and/or the personal assistant to detect the user's presence and determine what he is watching. Some of the components that may be used include a camera and face recognition software, an RFID transmitter and receiver, a fingerprint sensor, a keypad, or any other hardware, software or encoded logic that may be useful in determining the presence of a user. In addition to the variety of components that may used, there may be several different ways of determining the users presence and what he is watching. For example, some of the techniques may include determining the status of one or more pieces of equipment (e.g., what equipment is on or off), determining the status of the media to be viewed (e.g., what channel or type of media is being used), determining the user's identification through a login process (e.g., the user enters his unique code), or any other process or method that may be able to determine the presence of the user and the show he is watching. As may be apparent, different embodiments may use a combination of the components and techniques mentioned above as well as any other desirable techniques or components.

At step 320 the rule is activated. Once the rule has been activated, any incoming communications will be processed according to the rule. In other words, once the user's show starts, any incoming communications will be rerouted or processed based on the user's instructions.

At step 330 a first communication is processed based on the rule. Because the rule may be configured by the user with any of a variety of different options, how the first communication is processed may also depend on the type of communication as well as the initiator. The first communication may be any type of communication, including, for example, a voice call, an email, a text message, a video call, or any other type of incoming communication. Similarly, the first communication may be from any of wide variety of initiators, including both those the user knows and those he does not know. Thus, based on the rules a voice call may be processed differently than an email; a voice call from a friend or particular initiator may be processed differently than a voice call from an unknown initiator or other known initiators.

The processing of the first communication may be as varied as the features and technology of the connected components may allow. For example, in some embodiments the first communication may be rerouted without alerting the user until the show is over. In particular embodiments, the processing of the first communication may involve changing the way the user is notified of the communication (e.g., if a phone normally rings for incoming calls, the rule may specify that the phone is not to ring, but that a message is to be displayed on the TV).

At step 340 an alert is generated. Depending on the rule the alert may be generated at various different times. For example, the alert may be generated when the first communication is received or when the user has finished watching the show (e.g., at step 350). Not only may the rule effect the timing of the alert, it may also effect the content of the alert. For example, the alert may include a unique audible sound (e.g., a single beep as opposed to a repeated ringing sound). As another example, the alert may comprise a message that is displayed on a TV or sent to the user via email. In some cases, the message may be a generic message indicating that a communication has been received. In particular instances the message may contain more detailed information (e.g., information related to the ID of the initiator of the first communication, the type of the first communication, the time the first communication was received, the subject of the first communication, or any other data or information that may be retrieved from or about the first communication).

While the processing of only the first communication is depicted, any additional communications may also be processed according to the rule. However, at steps 350 and 360 a second event is detected and the rule is deactivated. Once the rule has been deactivated, any subsequent incoming communication may be processed according to the normal operations of the respective device (e.g., the phone may ring).

Detecting the second event may be as varied as detecting the first event. In general, the second event indicates that the first user is no longer watching his preferred show and thus no longer wishes to not be disturbed. For example, the second event may be detected when the show is over, the user has changed the channel or stopped playback of the show, the user has logged-out, the user has turned off one or more devices providing the show (e.g., a DVD player), the user has left the room or otherwise done something indicating that he is no longer watching the show, or any other factor or indication that may be used to determine that the user no longer wishes to not be disturbed.

While the above example may be understood as a “phone call” placed using a “phone.” It should be understood that a “phone call” may consist of an audio only call, a video call, an IM contact, SMS message, or any other multimedia message or communication; and that a “phone” may be any type of communication endpoint, such as a PDA, a terminal or any other endpoint which may facilitate a multimedia communications. For example, a TV screen and any associated or attached components may serve as an endpoint for both rendering the show to the users as well as a multimedia communication endpoint.

Some of the steps illustrated in FIG. 3 may be combined, modified or deleted where appropriate, and additional steps may also be added to the flowchart. Additionally, steps may be performed in any suitable order without departing from the spirit or scope of the disclosure.

While various implementations and features are discussed with respect to multiple embodiments, it should be understood that such implementations and features may be combined in various embodiments. For example, features and functionality discussed with respect to a particular figure such as one of FIGS. 1 or 2 may be used in connection with features and functionality discussed with respect to another such figure according to operational needs or desires.

Although particular embodiments have been described in detail with reference to particular elements and components, it should be understood that various other changes, substitutions, and alterations may be made hereto without departing from the spirit or scope of this disclosure. These changes, substitutions, and alterations may be incorporated into particular embodiments not depicted herein. For example, although particular embodiments have been described with reference to a number of elements included within home media network 100, these elements may be combined, rearranged or positioned in order to accommodate particular home media needs. In addition, any of these elements may be provided as separate external components to home media network 100 or each other where appropriate. There may be great flexibility in the arrangement of these elements as well as their internal components.

What is claimed is:

1. A method comprising:
receiving a first user profile comprising at least one rule associated with at least one show, the at least one rule activated upon the occurrence of a first event;
detecting the occurrence of the first event; and
upon detecting the occurrence of the first event:
activating the at least one rule; and
processing a first communication based on the at least one rule.

2. The method of claim 1, wherein processing the first communication based on the at least one rule comprises rerouting the first communication based on the at least one rule.

3. The method of claim 1, wherein processing the first communication based on the at least one rule comprises transmitting the first communication to the first user, the first communication comprising an alert notifying the first user that a second user is viewing the at least one show.

4. The method of claim 1, wherein detecting the occurrence of the first event comprises detecting an event selected from the group consisting of detecting the presence of the first user, and determining that the at least one show is being viewed.

5. The method of claim 1:
wherein the at least one rule is deactivated upon the occurrence of a second event; and
further comprising:
detecting the occurrence of the second event; and
upon detecting the occurrence of the second event, deactivating the at least one rule.

6. The method of claim 5, wherein the second event comprises an event selected from the group consisting of the turning off of a television being used to view the at least one show, the logging-off of the first user, the changing of the channel, the turning off of the source of the at least one show, the pausing of the at least one show, the stopping of the at least one show, and the movement of the first user from in front of a television being used to watch the at least one show.

7. The method of claim 1:
further comprising receiving a second user profile comprising at least one rule regarding viewing at least one show; and
wherein processing a first communication based on the at least one rule comprises processing the first communication based on the at least one rule and at least one meta rule, the at least one meta rule determining priority between the at least one rule of the first user profile and the at least one rule of the second user profile.

8. The method of claim 1, further comprising generating an alert comprising information indicative of the identity of an initiator of the first communication.

9. The method of claim 1, wherein processing a first communication based on the at least one rule comprises:
determining an identity of an initiator of the first communication; and
determining a destination for routing of the first communication based on the identity of the initiator of the first communication and the at least one rule.

10. The method of claim 1, wherein processing a first communication based on the at least one rule comprises notifying an initiator of the first communication of when the first user may be available based on the length of the at least one show.

11. A system comprising:
an interface operable to:
receive a first user profile comprising at least one rule associated with at least one show, the at least one rule activated upon the occurrence of a first event; and
detect the occurrence of the first event; and
a processor coupled to the interface and operable to, upon detecting the occurrence of the first event:
activate the at least one rule; and
process a first communication based on the at least one rule.

12. The system of claim 11, wherein the processor operable to process the first communication based on the at least one rule comprises a processor operable to reroute the first communication based on the at least one rule.

13. The system of claim 11, wherein the processor operable to process the first communication based on the at least one rule comprises a processor operable to transmit the first communication to the first user, the first communication comprising an alert notifying the first user that a second user is viewing the at least one show.

14. The system of claim 11, wherein the interface operable to detect the occurrence of the first event comprises an interface selected from the group consisting of an interface operable to detect the presence of the first user and an interface operable to determine that the at least one show is being viewed.

15. The system of claim 11, wherein:
the at least one rule is deactivated upon the occurrence of the second event;
the interface is further operable to detect the occurrence of the second event; and
the processor is further operable to, upon detecting the occurrence of the second event, deactivate the at least one rule.

16. The system of claim 15, wherein the second event comprises an event selected from the group consisting of the turning off of a television being used to view the at least one show, the logging-off of the first user, the changing of the channel, the turning off of the source of the at least one show, the pausing of the at least one show, the stopping of the at least one show, and the movement of the first user from in front of a television being used to watch the at least one show.

17. The system of claim 11, wherein the interface is further operable to, upon detecting the occurrence of the first event, generate an alert comprising information indicative of the identity of an initiator of the first communication.

18. The system of claim 11, wherein the processor operable to process a first communication based on the at least one rule comprises a processor operable to:
determine an identity of an initiator of the first communication; and
determine a destination for routing of the first communication based on the identity of the initiator of the first communication and the at least one rule.

19. The system of claim 11, wherein the processor operable to process a first communication based on the at least one rule comprises a processor operable to notify an initiator of the first communication of when the first user may be available based on the length of the at least one show.

20. A system comprising:
a means for receiving a first user profile comprising at least one rule associated with at least one show, the at least one rule activated upon the occurrence of a first event;
means for detecting the occurrence of the first event;
upon detecting the occurrence of a first event;
means for activating the at least one rule; and
means for processing a first communication based on the at least one rule;
means for detecting the occurrence of the second event; and
upon detecting the occurrence of the second event, means for deactivating the at least one rule.
